(19) United States
(12) Patent Application Publication
(10) Pub. No.: US 2023/0215033 A1
(43) Pub. Date: Jul. 6, 2023

(54) CONVEX GEOMETRY IMAGE CAPTURE

(71) Applicant: Samasource Impact Sourcing, Inc., San Francisco, CA (US)

(72) Inventor: Eric Simonton, Portage, MI (US)

(21) Appl. No.: 17/565,670

(22) Filed: Dec. 30, 2021

(51) Int. Cl. G06T 7/64

(52) U.S. Cl. CPC G06T 7/64; G06T 2207/10028

(57) ABSTRACT

Systems and methods are provided for identifying data points in a three-dimensional image. The method receives an input image with data points having coordinates in a three-dimensional (3D) image space. A convex geometry is created that surrounds a first group of data points. The convex geometry is composed of planes with faces, where each plane only intersects planes from adjacent faces. For each plane, a first face is determined, and every data point associated with the plane's first face is identified. Common identified data points (data points associated with every first face) are determined and presented as a representation of the first group of data points. In one aspect, the first face is defined as an outside face, so that the step of identifying every data point associated with the plane's first face becomes the identification of every data point not faced by the plane's outside face.

### RELATED APPLICATIONS

Any and all applications, if any, for which a foreign or domestic priority claim is identified in the Application Data Sheet of the present application are hereby incorporated by reference under 37 CFR 1.57.

### BACKGROUND OF THE INVENTION

### 1. Field of the Invention

This invention generally relates to machine learning (ML) systems and, more particularly, to systems and methods for efficiently identifying the data points representing objects of interest in a three-dimensional (3D) image.

### 2. Description of the Related Art

FIG. 1 is a depiction of a 3D point cloud, such as might be presented on a two-dimensional display (prior art). Lidar sensors collect images of the world around them as a set of points corresponding to each place the laser hits a surface. Among other values, these points contain the physical position of each point relative to the sensor. Together these points can be displayed as a point cloud, where a viewer of the scene can make out a couple cars, a trailer, a van, surrounding buildings, etc. This technology may be used, for example, in support of the software needed to create self-driving cars. A car equipped with Lidar sensors may supply data used in ML models that are trained to recognize important objects like other cars, pedestrians, and road signs.

FIG. 2 is a diagram depicting the identification of points depicting a car from FIG. 1 (prior art). To train those models training data is used, where each point is given a corresponding label, like “car 1”, “car 2”, “van 1”. To assist in visualization while a human is creating or correcting these labels, each label may be associated with a color or particular point shape. For example in FIG. 2 all the darker points have the same label: “car 1”.

As mentioned above, there are currently existing tools that a human operator could use to indicate which points to paint a given color or shape. Examples of conventional 2D paintbrush tools are Microsoft Paint and Photoshop. For example, the use of a paintbrush tool is common in 2D image editing software. The software needs to determine which points should be affected by the user action. However, point clouds can be composed of millions of points, and dragging a paintbrush can be very time consuming and processor intensive.

It would be advantageous if real-time annotation of a point cloud could be made faster and more accurate.

### SUMMARY OF THE INVENTION

Disclosed herein are systems and methods that can find all the data points within any arbitrary convex geometry. Existing tools can be used to create and position a convex type of polygon geometry in a three-dimensional (3D) image space, but the disclosed algorithm simplifies the identification of points inside the geometry to be painted. Alternatively stated, the algorithm turns any shape of convex geometry into a paintbrush without the necessity of writing special code for each shape. With large point clouds the software can become very sensitive to performance concerns. By having a single algorithm that can be used for painting any arbitrary convex geometry, focus can be directed to optimization and its reuse in a multitude of painting needs, confident that it is already performant.

Accordingly, a method is provided for identifying data points in a three-dimensional image. In one aspect, the method can be implemented as processor executable instructions stored in a non-transitory storage medium. The method receives an input image with data points having coordinates in a three-dimensional (3D) image space. For simplicity, it can be assumed that each data point, also referred to herein as a “point”, has an x, y, and z coordinate. A convex geometry is created that surrounds a first group of data points. The convex geometry is composed of planes with faces, where each plane only intersects planes from adjacent faces. For each plane, a first face is determined, and every data point associated with the plane's first face is identified. Common identified data points (data points associated with every plane's first face) are determined and presented as a representation of the first group of data points. For example, in the case of machine learning (ML) training data, the representation of the first group of data points may be labeled (annotated) by a human operator.

In one aspect, the first face is defined as an outside face, so that the step of identifying every data point associated with the plane's first face becomes the identification of every data point not faced by the plane's outside face. Prior to identifying every data point not faced by the plane's outside face, the method may determine a first outside sub-face having a coplanar orientation to a second outside sub-face, and in the interest of reducing processing time and storage, eliminate the second outside sub-face from the step of data point identification. Alternatively, the method could define the first face as the inside face so that the step of identifying every data point associated with the plane's first face becomes the identification of every data point faced by the inside face.

In one aspect, the step of creating the convex geometry includes creating sets of coplanar sub-faces, and associating each set of coplanar sub-faces with a corresponding plane. For example, the sub-faces may be triangles. Each sub-face is defined by a corresponding group of coordinates (i.e., x, y, z coordinates), and the step of associating each set of coplanar sub-faces with a corresponding plane includes the following substeps. A cross product vector is determined for the coordinates associated with each sub-face, and sub-faces having a common cross product vector are recognized as a single plane. A cross product vector direction is determined for each plane, and in response to the cross-product vector direction, the outside face of each plane is determined.

Then, the step of identifying every data point not faced by the plane's outside face includes the following substeps. A sample vector is calculated to each data point in the input image from a sample point on each plane outside face. For each plane, the dot product is determined between each sample vector and the cross product vector. The data points associated with dot products having a negative value are determined, which are the data points not faced by the plane's outside face.

In one aspect, in response to recognizing sub-faces having a common cross product vector as a plane, the method uses only one of the sub-faces for the identification of data points. More explicitly, determining a cross product vector for each sub-face includes the substeps of normalizing each cross product vector and determining normalized cross product vectors having the same value. Then, the using only one for the sub-faces having a common cross product vector includes using only one of the sub-faces sharing the same normalized cross product vector.

In a different aspect, a first convex geometry is created surrounding the first group of data points, and a second convex geometry is created surrounding a first subset of the first group of data points. As above, common identified data points are determined for each convex geometry. However, in this case the method subtracts the determined common identified data points associated with the second convex geometry from the determined common identified data points associated with the first convex geometry to create a second subset of the first group data points. The second subset of the first group of data points can then be presented. Alternatively, the use of multiple convex geometries can be used to add or combine data points.

Addition details of the above-described method and an associated system for the identification of data points in a 3D image are provided below.

### BRIEF DESCRIPTION OF THE DRAWINGS

FIG. 1 is a depiction of a 3D point cloud, such as might be presented on a two-dimensional display (prior art).

FIG. 2 is a diagram depicting the identification of points depicting a car from FIG. 1 (prior art).

FIG. 3 is a schematic block diagram of a system for identifying data points in a three-dimensional image.

FIGS. 4A and 4B are a flowchart illustrating a method for identifying data points in a three-dimensional image.

FIG. 5 is an input image drawing depicting the first group of data points representing a partial view of a car in a 3D image space.

FIG. 6 is a drawing depicting a convex geometry in the shape of a rectangular box with faces 602, 604, 606, 608, 610, and 612.

FIG. 7 is a drawing depicting the first faces 604, 608, and 612.

FIG. 8 is a drawing depicting the data points associated with first face 604.

FIG. 9 is a drawing depicting the faces as composed from triangular sub-faces.

FIG. 10 is a diagram depicting the cross product vector for face 612.

FIG. 11 is a diagram depicting the cross product vectors for the sub-faces associated with faces 612, 608, and 604.

FIG. 12 is a drawing depicting the cross products associated with negative dot products.

FIG. 13 is a diagram depicting the identified first group of data points, graphically presented using the above-described method.

FIG. 14 is a drawing depicting the deduplication of sub-faces with equivalent normal vectors.

FIGS. 15A and 15B are diagrams depicting the use of a convex geometry as a data point subtractor.

FIGS. 16A and 16B are diagrams depicting the use of multiple convex geometries.

FIG. 17 is a cylindrical convex geometry.

FIG. 18 is a diagram depicting a cone convex geometry paintbrush using a perspective camera to present the input image.

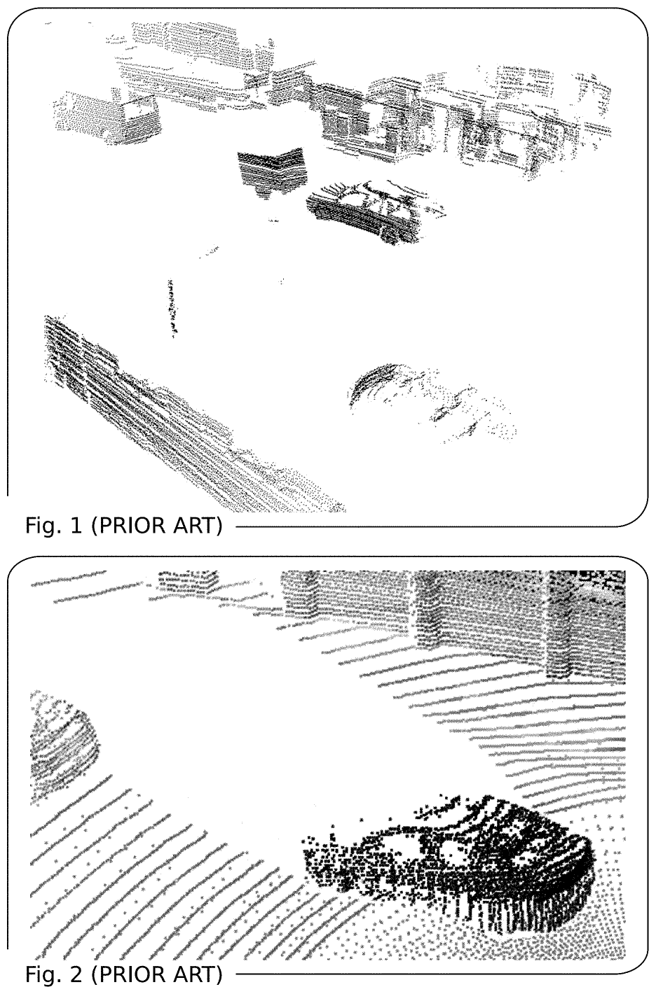

### DETAILED DESCRIPTION

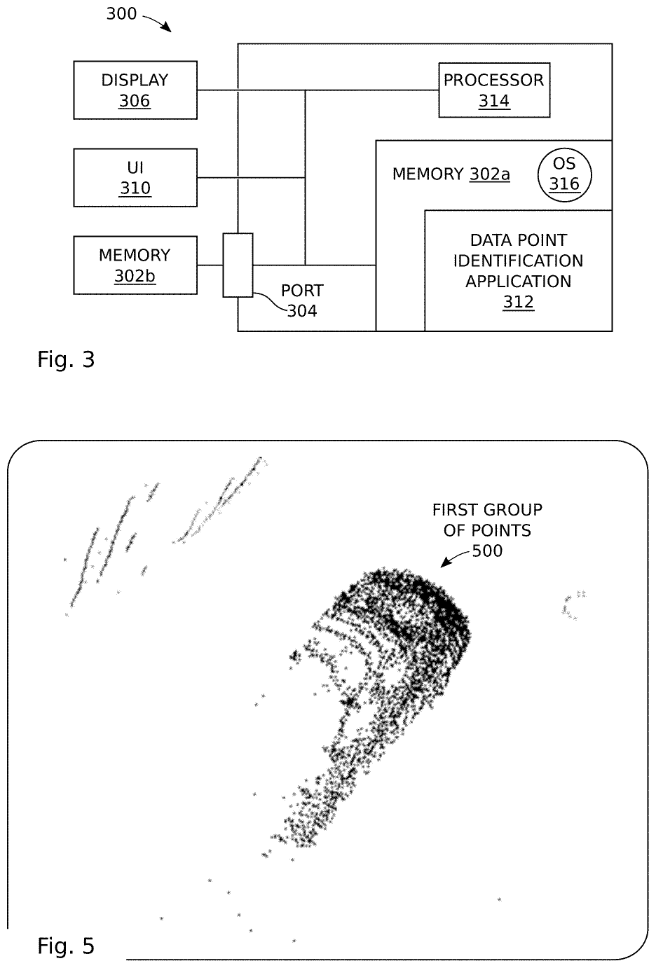

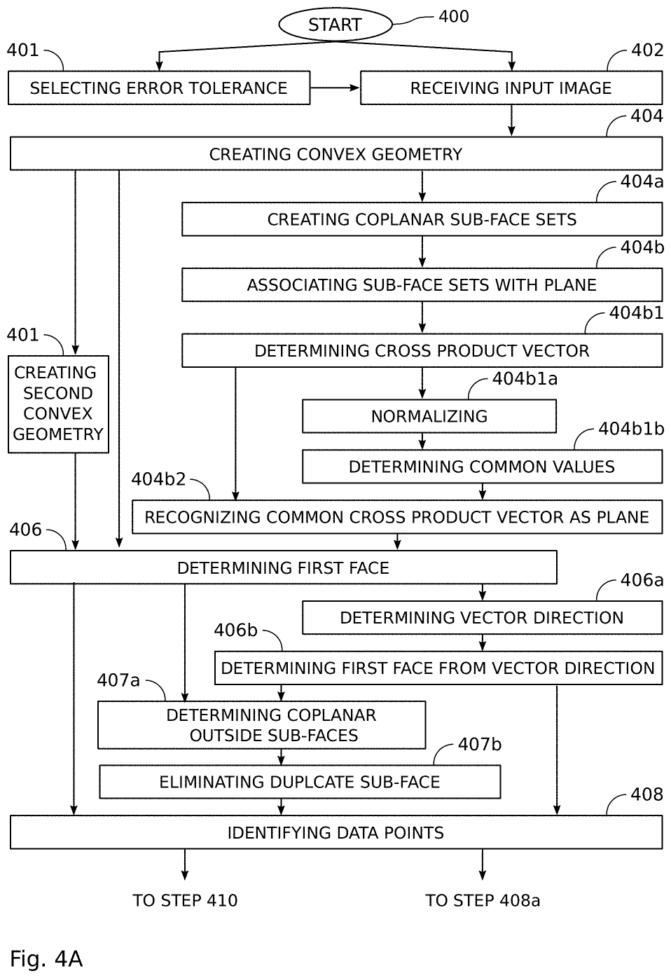

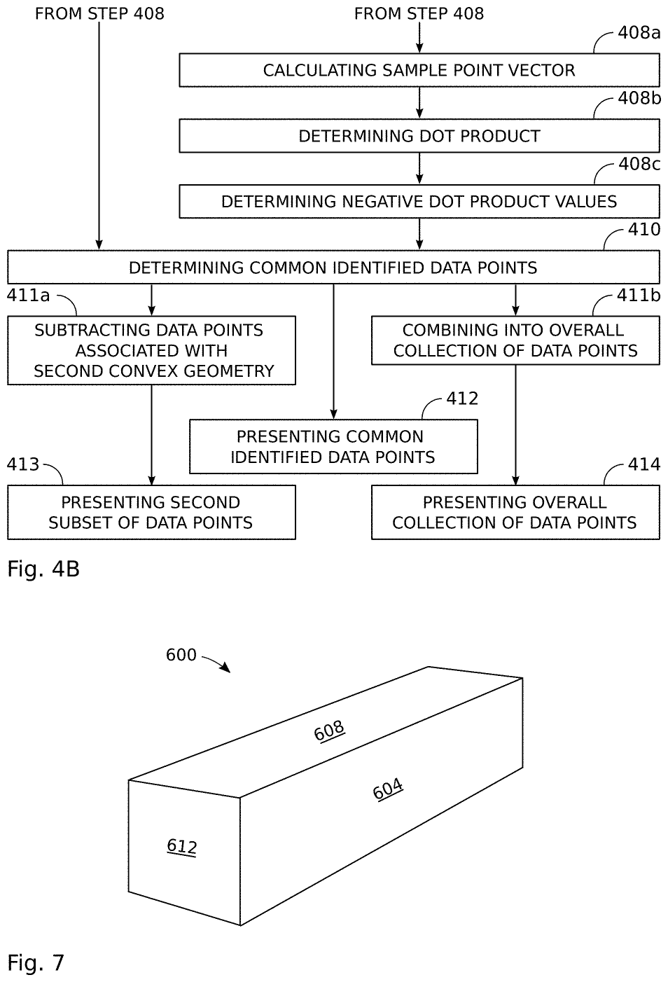

FIG. 3 is a schematic block diagram of a system for identifying data points in a three-dimensional image. The system 300 comprises a non-transitory memory. Shown are a hard drive memory 302a and a portable memory device 302b, such as a CD disk or thumb drive to name a few examples, connected to peripheral port 304. A display 306 has an interface on bus 308 to accept an input image with data points having coordinates in a three-dimensional (3D) image space. A user interface (UI) 310 has an interface, such as a keyboard, mouse, touchpad, touchscreen, trackball, stylus, cursor direction keys, or voice-activated software/microphone, accepting commands for creating a convex geometry on the display 306 surrounding a first group of data points. As explained in greater detail below, the convex geometry comprises planes with faces, with each plane only intersecting planes from adjacent faces. A data point identification software application 312 is stored in the memory 302a, including processor executable instructions for accepting the convex geometry from the display 306, determining a first face for each plane, identifying every data point associated with the first face for each plane, determining common identified data points, and providing the common identified data points to the display for presentation as a representation of the first group of data points. Details of the data point identification application are presented, beginning with the description of FIGS. 4A and 4B, below. Alternatively, but not shown, the application 312 may reside in portable memory device 302b. The system 300 further comprises a processor 314 connected to bus 308.

Processor 314 generally represents any type or form of processing unit capable of processing data or interpreting and executing instructions. Processor 314 may represent an application-specific integrated circuit (ASIC), a system on a chip (e.g., a network processor), a hardware accelerator, a general purpose processor, and/or any other suitable processing element. As is common with most computer system, processing is supported through the use of an operating system (OS) 316 stored in memory 302a.

System memory 302a generally represents any type or form of non-volatile (non-transitory) storage device or medium capable of storing data and/or other computer-readable instructions. Examples of system memory 302a may include, without limitation, Random Access Memory (RAM), Read Only Memory (ROM), flash memory, or any other suitable memory device. Although not required, in certain embodiments computing system 300 may include both a volatile memory unit and a non-volatile storage device. System memory 302a may be implemented as shared memory and/or distributed memory in a network device. Furthermore, system memory 302a may store packets and/or other information used in networking operations.

In certain embodiments, exemplary computing system 300 may also include one or more components or elements in addition to processor 314 and system memory 302a. For example, computing system 300 may include a memory controller, an Input/Output (I/O) controller, and a communication interface (not shown), as would be understood by one with ordinary skill in the art. Further, examples of communication infrastructure include, without limitation, a communication bus (such as a Serial ATA (SATA), an Industry Standard Architecture (ISA), a Peripheral Component Interconnect (PCI), a PCI Express (PCIe), and/or any other suitable bus), and a network. For simplicity the communication between devices in system 300 is shown as using bus line 308, although in practice the devices may be connected on different lines using different communication protocols.

FIGS. 4A and 4B are a flowchart illustrating a method for identifying data points in a three-dimensional image. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. In one aspect, the method can be stored in a non-transitory memory device as a set of processor instructions, and enabled through the use of a computer system, such as the one described in FIG. 3. The method starts at Step 400.

Step 402 receives an input image with data points having coordinates in a 3D image space. As used herein, a data point or point is a set of coordinates in three dimensional space defined by x, y, and z coordinates.

FIG. 5 is an input image drawing depicting the first group of data points 500 representing a partial view of a car in a 3D image space.

Returning to FIG. 4A, Step 404 creates a convex geometry surrounding a first group of data points. The convex geometry comprises planes with faces, where each plane only intersects planes from adjacent faces. Typically this step is performed by a human operator. In some aspects, predetermined convex geometries are provided which the operator manipulates to shape and size. Although the first group of data points have coordinates in three dimensional space, the image received in Step 402 and the convex geometry created in Step 404 are typically presented on two-dimensional display screens.

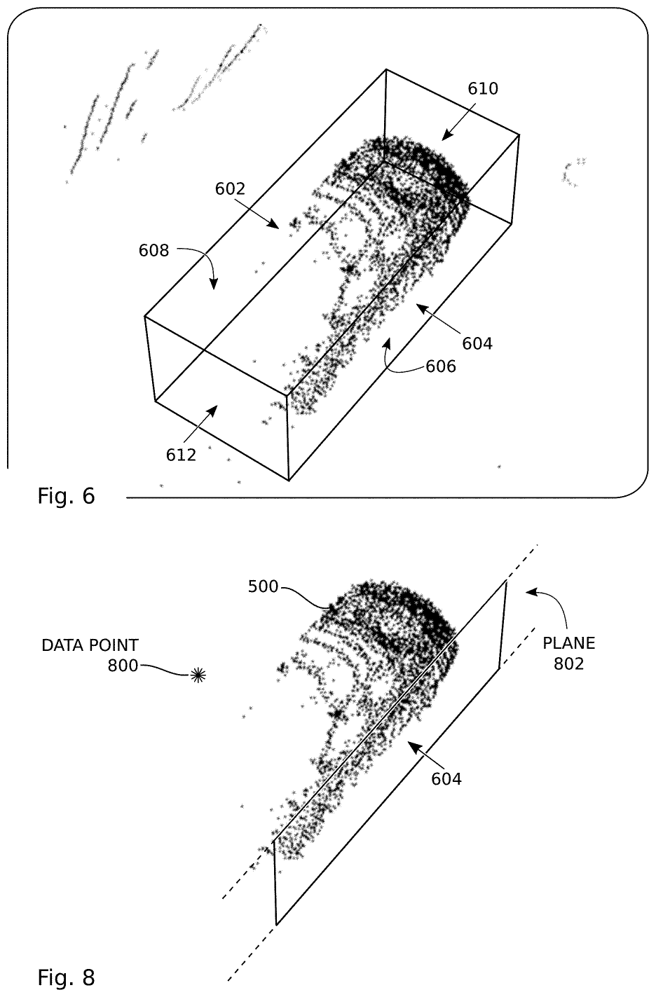

FIG. 6 is a drawing depicting a convex geometry 600 in the shape of a rectangular box with faces 602, 604, 606, 608, 610, and 612.

Returning to FIG. 4A, Step 406 determines a first face for each plane.

FIG. 7 is a drawing depicting the first faces 604, 608, and 612. In this example, the first face is the outside face of the plane, which is the face of the plane directed away from the first group of data points.

Returning to FIG. 4, Step 408 identifies every data point associated with the first face for each plane. Alternatively, the method can define the inside faces of the planes as the first face.

FIG. 8 is a drawing depicting the data points associated with first face 605. In this example the first face is an outside face, and the outside face of the plane is directed away from the first group of data points 500. It should be understood that the data points not faced by each plane's outside face may be different, as the data points “not seen” may include ones not included inside the convex geometry 600. For example, data point 800, located outside the convex geometry 600 will only be “not seen” as faced away from the outside face 606 of plane 802. However, although only one plane is shown in this figure, it should be understood that the same first group of data points 500 is faced away from the outside face of each plane defining the convex geometry. Alternatively, the method can define the inside faces of the planes as the first face, in which case the method identifies every data point faced by the plane's first (inside) surface.

Returning to FIG. 4B, Step 410 determines common identified data points, and Step 412 presents the common identified data points as a representation of the first group of data points, presented as a graphic image or as a list of data points.

In one aspect as mentioned above, determining the first face in Step 406 includes determining an outside face of a plane, and identifying every data point associated with the plane's first face in Step 408 includes identifying every data point not faced by the plane's outside face. Then, prior to identifying every data point not faced by the plane's outside face, Step 407a determines a first outside sub-face having a coplanar orientation with respect to a second outside sub-face. As explained below, coplanar sub-faces together form a face in the plane, and thus, a portion of the plane. Step 407b eliminates the second outside sub-face from the step of data point identification. Looking ahead to FIG. 9, outside sub-face 604a is coplanar to outside sub-face 604b. Since both of these outside sub-faces face away from the first group of points, and are in the same face (plane), it is only necessary to identify the data points faced away from a single plane associated with one of these outside sub-faces.

Returning to FIG. 4A, thus, creating the convex geometry in Step 404 includes the following substeps. Step 404a creates sets of coplanar sub-faces, and Step 404b associates each set of coplanar sub-faces with a corresponding plane. For example, the sub-faces may be triangular sub-faces, see FIG. 9.

FIG. 9 is a drawing depicting the faces as composed from triangular sub-faces. Each face is represented as two triangular sub-faces in this example.

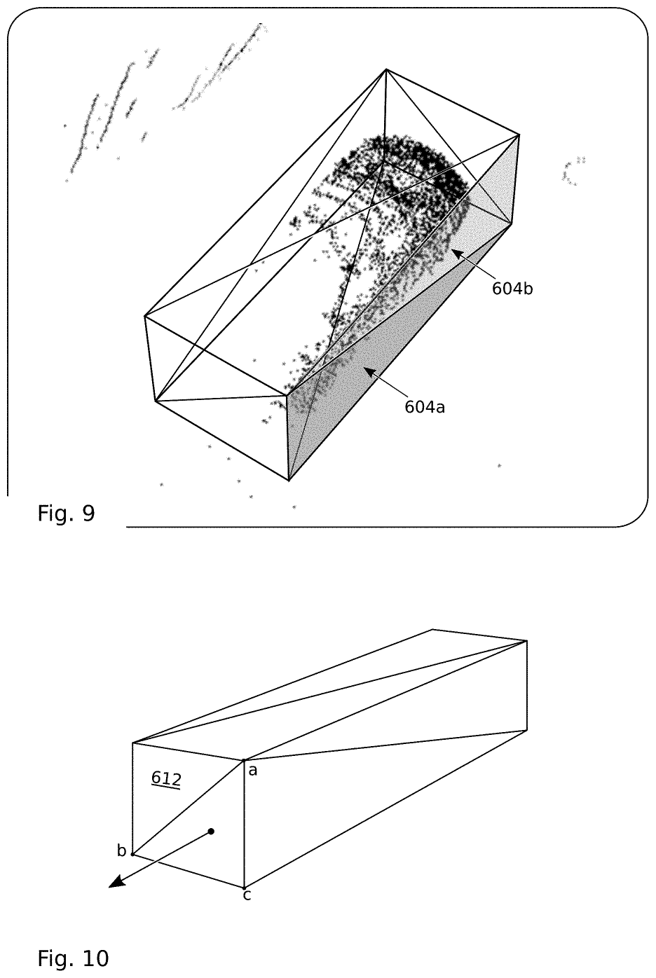

Returning to FIG. 4A, each sub-face is defined by a corresponding group of coordinates, and associating each set of coplanar sub-faces with a corresponding plane in Step 404b includes the following substeps. Step 404b1 determines a cross product vector for coordinates associated with each sub-face. Step 404b2 recognizes sub-faces having a common cross product vector as being in the same plane. For simplicity, it is the faces (see FIG. 6), not the sub-faces that would be seen by a human operator creating the convex geometry. If the sub-face is a triangle for example, the cross product of two non-parallel vectors in the plane can be taken using the three coordinates in the triangle. Referencing FIG. 10, vectors (c-b) and (a-b) may be chosen. However, there are many other combinations that could be chosen—the vectors between any two pairs of points in the plane will work as long as they are not parallel. As explained in more detail below, the direction of the cross product vector is important. Assuming vectors v1 and v2, it must be determined whether to calculate either v1×v2 or v2×v1. One calculation gives a vector pointing outward, and the other inward. In the outside face example provided herein, the method selects that calculation that provides the vector direction pointing outward.

More explicitly, determining the first face in Step 406 includes the following substeps. Step 406a determines a cross product vector direction for each sub-face, and in response to the cross-product vector direction, the first face (e.g. outside face in this example) of each plane is determined in Step 406b. Step 408 then identifies every data point not faced by the plane's outside face.

FIG. 10 is a diagram depicting the cross product vector for face 612. Coplanar triangles are converted into a plane, represented as a sample point in the triangle plus a normal (cross product) vector. In this example it is important for all the vectors to point outward, not inward. As mentioned above, the first face can alternatively be designated as the inside face, in which case the vector should point inward. To achieve the desired vector direction in this example the triangles are constructed such that their three data points (a, b, c) are arranged counter-clockwise when viewing that face from outside the convex geometry. Then, taking this cross product produces a vector pointing the correct direction: crossProduct (c-b, a-b).

FIG. 11 is a diagram depicting the cross product vectors for the sub-faces associated with faces 612, 608, and 604. Although not shown, twelve cross products are calculated, one for each of the twelve triangles.

Returning to FIG. 4A, identifying every data point not faced by the plane's outside face (Step 408) includes the following substeps. Step 408a calculates a sample vector to each data point in the input image from a sample point on each plane's outside face. Step 408b determines the dot product between each sample vector and the cross product vector for each plane's outside face, and Step 408c determines data points associated with dot products having a negative value. In this outside face example, only the negative value dot products are of interest, and in the interest of saving storage and reducing processing time, only the common identified data points are recorded (stored in memory).

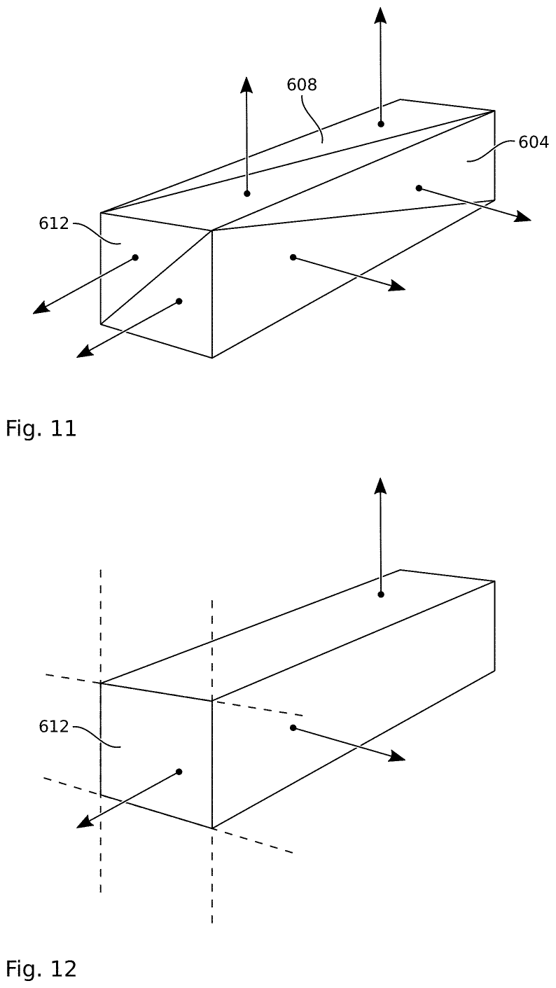

FIG. 12 is a drawing depicting the cross products associated with negative dot products. Using face 612 as an example, it can be seen that the planes extend out infinitely with the dotted lines from the outside faces of the convex geometry 600. All planes similarly extend infinitely. To determine if a data point is contained within the convex geometry, it is tested against each of the six planes. If it is on the same side of the plane face in which the normal cross product vector points, it is not contained within the convex geometry. If a data point is on the opposite side from which the cross product vector points, for all six planes, then the data point is within the convex geometry, which in this case is a cuboid.

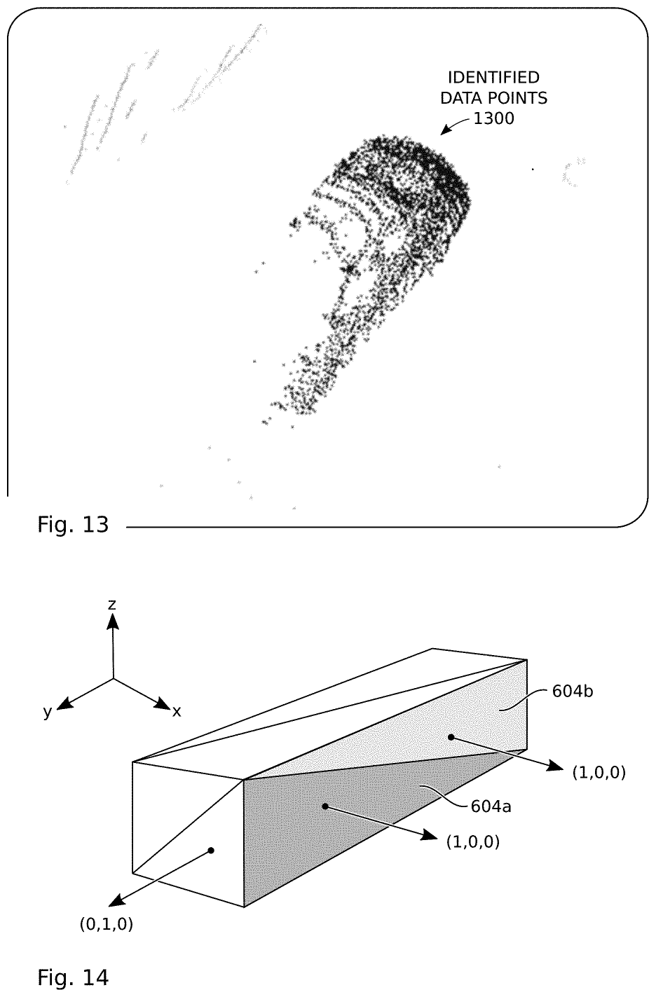

FIG. 13 is a diagram depicting the identified first group of data points 1300, graphically presented using the above-described method.

Returning to FIG. 4A, and as noted above, Step 407a determines coplanar sub-faces, so that Step 407b, in response to recognizing sub-faces having a common cross product vector, uses only one of the sub-faces for data point identification. More explicitly, determining a cross product for each sub-face in Step 404b1 includes the following substeps. Step 404b1a normalizes each cross product vector. Step 404b1b determines normalized cross product vectors having the same value. Then, recognizing sub-faces in the same plane in Step 404b2 includes using only one of the sub-faces sharing the same normalized cross product vector value. In one aspect, Step 401 selects an error tolerance, and determining normalized cross product vectors having the same value in Step 404b 1b includes determining normalized cross product vectors having the same value within the selected error tolerance.

FIG. 14 is a drawing depicting the deduplication of the sub-faces with equivalent normal vectors. In the diagram, the vectors extending from sub-faces 604a and 604b appear to be parallel. To determine if the vectors are parallel, first they are normalized, i.e. making a vector that points the same direction but has length 1. This is achieved by dividing each of the x, y, and z components of the vector by its length, making parallel vectors into normalized equal vectors.

Returning to FIG. 4A, in one aspect, the input image received in Step 402 includes data points depicting a 3D object comprising the first group of data points, and the convex geometry created in Step 404 surrounds the 3D object. As shown in the figures described above, the 3D object is a car and the convex geometry is a cuboid. In other aspects, Step 404 may create a first convex geometry surrounding the first group of data points and Step 405 may create a second convex geometry surrounding a first subset of the first group of data points.

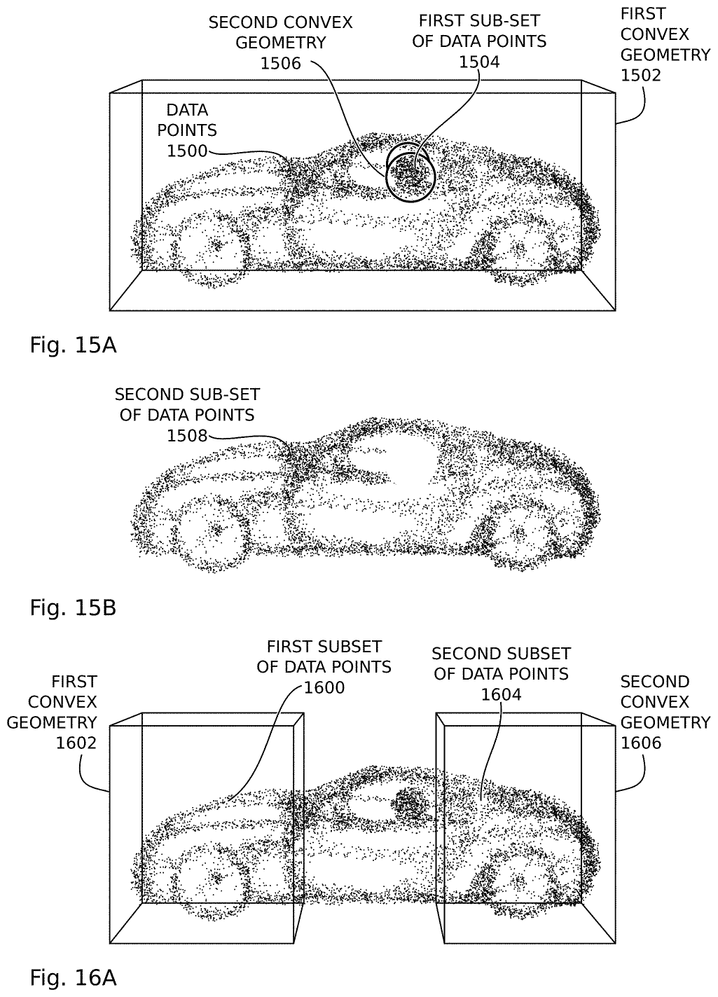

FIGS. 15A and 15B are diagrams depicting the use of a convex geometry as a data point subtractor. In FIG. 15A depicts a first group of data points, in the shape of a car, a first convex geometry 1502 in the shape of a cuboid surrounding the first group of data points, a first subset of the first group of data points 1504, and a second convex geometry 1506, in the shape of a cylinder, surrounding the first subset of data points.

Returning to FIG. 4B, determining common identified data points in Step 410 includes, for each convex geometry 1502 and 1506, determining common identified data points. That is, the common identified data points are determined separately for each geometry. Then, Step 411a subtracts the determined common identified data points associated with the second convex geometry from the determined common identified data points associated with the first convex geometry to create a second subset of the first group data points. Step 413 presents the second subset of the first group of data points (1508, see FIG. 15B).

In other aspects, Step 404 may create a plurality of convex geometries, with each convex geometry surrounding a subset of the first group of data points.

FIGS. 16A and 16B are diagrams depicting the use of multiple convex geometries. Shown in FIG. 16A is a first subset 1600 of first group of data points, a first convex geometry 1602 in the shape of a cuboid surrounding the first subset group of data points, a second subset 1604 of the first group of data points, and a second convex geometry 1606, in the shape of a cuboid, surrounding the second subset of data points.

Returning to FIG. 4B, determining common identified data points in Step 410 includes, for each convex geometry, determining common identified data points. That is, the common identified data points are determined separately for each geometry. Then, Step 411b combines the determined common identified data points associated with each convex geometry into an overall collection of data points, and Step 414 presents the overall collection of data points (1608, see FIG. 16B). Of course, the method can be extended so that a plurality of convex geometries can be used to completely surround the first group of data points.

Below is listed pseudo-code substantially enabling the method of data point identification presented in FIGS. 4A and 4B.

```
function findPointsInsideGeometry(geometry, points) {
  const planes = createPlanesFrom(geometry.triangles);
  deduplicate(planes);
  return findPointsInsidePlanes(planes, points);
}
function createPlanesFrom(triangles) {
  return geometry.triangles.map((triangle) =>
    createPlaneFromCoplanarPoints(triangle.a, triangle.b,
triangle.c)
  );
}
// We expect the triangles that form the geometry to be
constructed
// such that their three points a, b and c are arranged
// counter-clockwise when viewed from outside the shape.
function createPlaneFromCoplanarPoints(a, b, c) {
  return {
    // This cross product gives us the a vector that is
orthogonal
    // to the plane, pointing the direction that is
outward wrt the
    // shape.
    normalVector: normalize(crossProduct(c − b, a − b)),
    samplePoint: a,
  }
}
// There are a small number of planes, and a huge number
of points.
// So it is worth spending compute time to eliminate
duplicates that
// came from multiple triangles that comprise a single
face of the
// geometry.
function deduplicate(planes) {
// Compare each plane to all the others. If multiple of
them have
  // the same normal vector, only keep one. (Two faces of
a convex
  // geometry cannot share the same normal vector.)
  // Look for an approximate match, because of
rounding/truncation
  // errors in the math that creates the geometries and
planes.
}
function findPointsInsidePlanes(planes, points) {
  return points.filter((point) =>
    !planes.some((plane) => planeFaces(point, plane))
  );
}
function planeFaces(point, plane) {
  // Find a sample vector from the plane to the point.
The dot product
  // will be positive or negative depending on whether
that vector
  // points closer to the same direction as “outward” wrt
the shape
  // than “inward”.
  const directionToPoint = point − plane.samplePoint;
  return dotProduct(directionToPoint, plane.normalvector)
> 0;
      }
```

Below is an alternative explanation of the method for determining data points in a 3D image space.

1. Create a face from coplanar triangles (i.e., sub-face) in the geometry;

a. Map each triangle to a normal vector that points outward, along with 1 sample point from the triangle. Those two things together are how a plane is represented;

2. Deduplicate sub-faces;

a. Normalize all the cross product (normal) vectors (divide each of their coordinates by their length);

b. Eliminate all but one of each sub-face that shares the same normal vector;

3. Find the points that are inside all the faces. For each point:

a. For each face in turn, create a vector from its sample point to this point;

b. If that dot product is positive for any face, eliminate this point;

c. If the dot product is negative for all faces, add it to the final list.

The data point identification method presented above is not limited to any particular convex geometry shape. In addition to cuboids, a cylinder may be used as a convex geometry. It is a natural and useful tool to give the users is a simple paintbrush. A circle on the screen follows their mouse, so that as the user drags, all the points that are visually within the circle are painted. To power such a tool a cylinder can be approximated using a circle, positioned under the user's mouse cursor, and oriented such that the end is pointing directly at the camera. Then, the data point identification algorithm presented above can be used to “find” all points that are visually within the circular cursor.

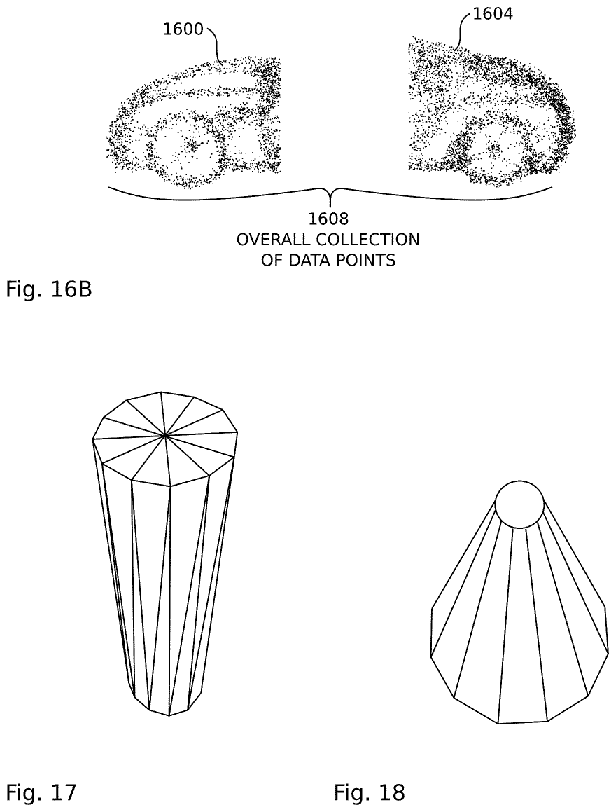

FIG. 17 is a cylindrical convex geometry. The geometry is composed of 24 triangles along the sides, 12 triangles on the top, and 12 triangles on the bottom. As described above, the data point identification algorithm combines the triangle sub-faces into faces for presentation on a display to the human operator, and uses only one of the coplanar sub-faces for the calculation of sample vectors. In some aspects, the paintbrush tool adjusts for 3D depth by automatically extending a 2D circle into a cylinder.

FIG. 18 is a diagram depicting a cone convex geometry paintbrush using a perspective camera to present the input image. If the input image is perspective camera, then adjacent points in the distance will appear on a display as being closer together than they actually are in 3D space, which makes the use of a 2D circle to represent a cylinder problematic. In that case the cylinder is adjusted to be more like a cone, such that the near and far ends, while having a different circumference in a 3D image space, have the same circumference when viewed on a 2D display. In some aspects, the paintbrush tool adjusts for perspective by automatically extending a 2D circle into a cone.

Another type of convex geometry is a sphere, with planar surfaces, that starts small when first initiated. As the mouse is dragged outward the sphere grows, painting anything inside it. As noted above, the convex geometry is not limited to any particular shape, as long as the plane faces only intersect adjacent plane faces.

A system and method have been provided for identifying data points in a 3D image. Examples of particular geometries and routines have been presented to illustrate the invention. However, the invention is not limited to merely these examples. Other variations and embodiments of the invention will occur to those skilled in the art.

I claim:

1. A method for identifying data points in a three-dimensional image, the method comprising:
receiving an input image with data points having coordinates in a three-dimensional (3D) image space;
creating a convex geometry surrounding a first group of data points, the convex geometry comprising planes with faces, where each plane only intersects planes from adjacent faces;
for each plane, determining a first face;
for each plane, identifying every data point associated with the first face;
determining common identified data points; and,
presenting the common identified data points as a representation of the first group of data points.

2. The method of claim 1 wherein determining the first face includes determining an outside face;
wherein identifying every data point associated with the first face includes identifying every data point not faced by the plane's outside face;
the method further comprising:
prior to identifying every data point not faced by the plane's outside face, determining a first outside sub-face having a coplanar orientation with respect to a second outside sub-face; and,
eliminating the second outside sub-face from the step of data point identification.

3. The method of claim 1 wherein creating the convex geometry includes:
creating sets of coplanar sub-faces; and,
associating each set of coplanar sub-faces with a corresponding plane.

4. The method of claim 3 wherein the sub-faces are triangular surfaces.

5. The method of claim 3 wherein each sub-face is defined by a corresponding group of coordinates;
wherein associating each set of coplanar sub-faces with a corresponding plane includes:
determining a cross product vector for coordinates associated with each sub-face; and,
recognizing sub-faces having a common cross product vector as a plane.

6. The method of claim 5 wherein determining the first face includes:
determining a cross product vector direction for each plane;
in response to the cross-product vector direction, determining an outside face of each plane; and,
wherein identifying every data point associated with the plane's first face includes identifying every data point not faced by the plane's outside face.

7. The method of claim 6 wherein identifying every data point not faced by the plane's outside face includes:
calculating a sample vector to each data point in the input image from a sample point on each plane's outside face;
determining the dot product between each sample vector and the cross product vector for each plane's outside face; and
determining data points associated with dot products having a negative value.

8. The method of claim 7 wherein determining common identified data points includes only recording common identified data points.

9. The method of claim 7 further comprising:
in response to recognizing sub-faces having a common cross product vector as a plane, using only one of the sub-faces to represent the outside face of the plane.

10. The method of claim 9 wherein determining a cross product for each sub-face includes:
normalizing each cross product vector;
determining normalized cross product vectors having the same value; and,
wherein using only one of the sub-faces for the identification of data points includes using only one of the sub-faces sharing the same normalized cross product vector value.

11. The method of claim 10 further comprising:
selecting an error tolerance; and,
wherein determining normalized cross product vectors having the same value includes determining normalized cross product vectors having the same value within the selected error tolerance.

12. The method of claim 1 wherein receiving the input image with data points includes receiving data points depicting a 3D object comprising the first group of data points; and,
wherein creating the convex geometry includes creating the convex geometry surrounding the 3D object.

13. The method of claim 1 wherein creating the convex geometry includes creating a first convex geometry surrounding the first group of data points;
the method further comprising:
creating a second convex geometry surrounding a first subset of the first group of data points.
wherein determining common identified data points includes, for each convex geometry, determining common identified data points;
the method further comprising:
subtracting the determined common identified data points associated with the second convex geometry from the determined common identified data points associated with the first convex geometry to create a second subset of the first group data points; and,
presenting the second subset of the first group of data points.

14. The method of claim 1 wherein creating the convex geometry surrounding a first group of data points includes creating a plurality of convex geometries, with each convex geometry surrounding a subset of the first group of data points;
wherein determining common identified data points includes, for each convex geometry, determining common identified data points;
the method further comprising:
combining the determined common identified data points associated with each convex geometry into an overall collection of data points; and,
presenting the overall collection of data points.

15. A non-transitory memory device storing a set of processor instructions for identifying data points in a three-dimensional (3D) image, the instructions comprising:
receiving an input image with data points having coordinates in a 3D image space;
creating a convex geometry surrounding a first group of data points, the convex geometry comprising planes with faces, where each plane only intersects planes from adjacent faces;
for each plane, determining a first face;
for each plane, identifying every data point associated with the first face;
determining common identified data points; and,
presenting the common identified data points as a representation of the first group of data points.

16. The instructions of claim 15 wherein determining the first face includes determining an outside face;
wherein identifying every data point associated with the first face includes identifying every data point not faced by the plane's outside face;
the instructions further comprising:
prior to identifying every data point not faced by the plane's outside face, determining a first outside sub-face having a coplanar orientation with respect to a second outside sub-face; and,
eliminating the second outside sub-face from the step of data point identification.

17. The instructions of claim 15 wherein determining the first face includes:
determining a cross product vector direction for each plane;
in response to the cross-product vector direction, determining an outside face of each plane; and,
wherein identifying every data point associated with the plane's first face includes identifying every data point not faced by the plane's outside face.

18. The instructions of claim 17 wherein identifying every data point not faced by the plane's outside face includes:
calculating a sample vector to each data point in the input image from a sample point on each plane's outside face;
determining the dot product between each sample vector and the cross product vector for each plane's outside face; and
determining data points associated with dot products having a negative value.

19. The instructions of claim 18 further comprising:
in response to recognizing sub-faces having a common cross product as a plane, using only one of the sub-faces for the identification of data points.

20. The instructions of claim 15 wherein creating the convex geometry includes creating a first convex geometry surrounding the first group of data points;
the instructions further comprising:
creating a second convex geometry surrounding a first subset of the first group of data points.
wherein determining common identified data points includes, for each convex geometry, determining common identified data points;
the instructions further comprising:
subtracting the determined common identified data points associated with the second convex geometry from the determined common identified data points associated with the first convex geometry to create a second subset of the first group data points; and,
presenting the second subset of the first group of data points.

21. The instructions of claim 15 wherein creating the convex geometry surrounding a first group of data points includes creating a plurality of convex geometries, with each convex geometry surrounding a subset of the first group of data points;
wherein determining common identified data points includes, for each convex geometry, determining common identified data points;
the instructions further comprising:
combining the determined common identified data points associated with each convex geometry into an overall collection of data points; and,
presenting the overall collection of data points.

22. A system for identifying data points in a three-dimensional image, the system comprising:
a non-transitory memory;
a display having an interface to accept an input image with data points having coordinates in a three-dimensional (3D) image space;
a user interface having an interface to accept commands for creating a convex geometry on the display surrounding a first group of data points, where the convex geometry comprises planes with faces, with each plane only intersects planes from adjacent faces;
a data point identification software application stored in the memory, including processor executable instructions for accepting the convex geometry from the display, determining a first face for each plane, identifying every data point associated with the first face for each plane, determining common identified data points, and providing the common identified data points to the display for presentation as a representation of the first group of data points; and,
a processor.
